(19) United States
(12) Patent Application Publication
(10) Pub. No.: US 2024/0413697 A1
(43) Pub. Date: Dec. 12, 2024

(54) STATOR FOR ELECTRIC MOTOR AND ASSOCIATED ELECTRIC MOTOR

(71) Applicant: VALEO SYSTÈMES D'ESSUYAGE, Le Mesnil Saint Denis (FR)

(72) Inventors: Jose Luis Herrada, Le Mesnil Saint Denis (FR); Mehdi Belhaj, Le Mesnil Saint Denis (FR)

(73) Assignee: VALEO SYSTÈMES D'ESSUYAGE, Le Mesnil Saint Denis (FR)

(21) Appl. No.: 18/697,207

(22) PCT Filed: Sep. 30, 2022
(86) PCT No.: PCT/EP2022/077315

§ 371 Date: Mar. 29, 2024

(30) Foreign Application Priority Data
Sep. 30, 2021 (FR) FR2110379

(51) Int. Cl. H02K 3/52; H02K 15/02

(52) U.S. Cl. CPC H02K 3/522; H02K 15/022; H02K 2203/12

(57) ABSTRACT

A stator for an electric motor is disclosed. The stator includes a star including a cylindrical central part around which a plurality of teeth extend radially, and a plurality of bobbins configured firstly to receive turns of a winding wire in order to form a coil, and secondly to be positioned around the respective teeth of the star. The star includes a plurality of openings formed in the central part thereof between the teeth. The bobbins include a positioning pin arranged on an inner radial part of the bobbin. When the bobbin is mounted on the star, the positioning pin is configured to be positioned in an associated opening of the star so as to position the bobbin relative to the star in the axial direction.

The present invention relates to the field of electric motors, and in particular to electric motors intended to equip electric bicycles.

Electric bicycles are becoming increasingly popular because of the ease of travel they provide while consuming less energy, having a lower environmental impact and costing less.

However, the use of an electric motor in an electric bicycle involves a number of constraints. In particular, it is necessary to provide a significant torque while limiting the weight and bulk of the electric motor as much as possible.

In order to limit the bulk, it is known practice to use stators in two parts also known as stators with separate teeth, in which the stator comprises an inner part referred to as the star comprising the teeth on which there are positioned bobbins around which the coils are wound, and an outer part, referred to as the ring or the yoke, which is arranged around the teeth.

The use of such a stator makes it possible to provide more space for the winding and therefore to maximize the available space and facilitate the winding of the winding wire around the teeth.

Moreover, it is known practice to produce the star and the yoke from a collection of small-thickness sheet-metal laminations that are superposed and assembled with one another axially. Such stacking implies a wide tolerance regarding the axial dimension of the star. However, it is necessary for the bobbins that are to be positioned on the teeth to be positioned very precisely in order to ensure correct operation of the motor.

Because of the wide tolerance, either it will not be possible for the bobbin to be inserted onto the tooth, or a large amount of clearance between the bobbin and the tooth may lead to malfunctioning of the electric motor. It is therefore appropriate to provide a solution that makes it possible to ensure that the bobbins are held in position on the teeth in the axial direction with a tighter tolerance.

To this end, the subject matter of the invention is therefore a stator for an electric motor, comprising:
a star comprising a cylindrical central part around which a plurality of teeth extend radially,
a plurality of bobbins configured firstly to receive turns of a winding wire in order to form a coil, and secondly to be positioned around the respective teeth of the star,
   wherein the star comprises a plurality of openings formed in the central part thereof between the teeth and wherein the bobbins comprise a positioning pin arranged on an inner radial part of the bobbin, when the bobbin is mounted on the star, said positioning pin being configured to be positioned in an associated opening of the star so as to position the bobbin relative to the star in the axial direction.

According to another aspect of the present invention, the bobbins have an annular overall shape of rectangular cross section.

According to another aspect of the present invention, the openings formed in the central part of the star are configured to allow and encourage circulation of the magnetic field formed by the permanent magnets of the rotor. The openings are formed in particular so as to prevent looping of the magnetic flux originating from the permanent magnets of the rotor that is intended to be positioned at the center of the stator. This is because looping of the magnetic flux through that wall of the star that lies between the teeth reduces the magnetic flux of the electric motor and therefore the performance of the electric motor.

According to another aspect of the present invention, the openings have a rectangular shape and the pins have a square or rectangular shape and are configured to come into contact with an edge of a respective opening in order to immobilize the bobbin in axial translation relative to the star in a first direction, the immobilization of axial translation in the second direction being provided by an internal wall of the bobbin in contact with a wall of the tooth.

According to another aspect of the present invention, the positioning pins have a chamfered part at their free end to facilitate insertion of the positioning pin into an opening of the star.

According to another aspect of the present invention, the star is formed from a stack of sheet-metal laminations assembled with one another in an axial direction.

According to another aspect of the present invention, the positioning pin is positioned facing an opening situated at one axial end of the star, the positioning pin being configured to come into contact with that edge of the opening that is situated at the axial end of the star.

According to another aspect of the present invention, the stator also comprises a yoke of cylindrical shape configured to be positioned around the star and the coils.

According to another aspect of the present invention, the yoke and the star are formed by cutting from a stack of sheet-metal laminations configured to be superposed axially.

The present invention also relates to an electric motor comprising a stator as described above.

The present invention also relates to a method for manufacturing a stator as described above, said manufacturing method comprising:
a step of cutting a stack of sheet-metal laminations to form a star comprising a plurality of teeth, and a yoke comprising a plurality of slots having a shape complementary to the ends of the teeth,
a step of forming a plurality of openings in the star between the teeth,
a step of forming the coils by winding a winding wire around bobbins comprising a positioning pin on a part that is radially internal when the bobbin is mounted on the star,
a step of positioning the coils on the teeth of the star, the positioning pin of the bobbins becoming inserted in an opening of the star,
a step of inserting the star into the yoke using axial translation.

Further features and advantages of the invention will become more clearly apparent from reading the following description, which is given by way of illustrative and non-limiting example, and the appended drawings, in which:

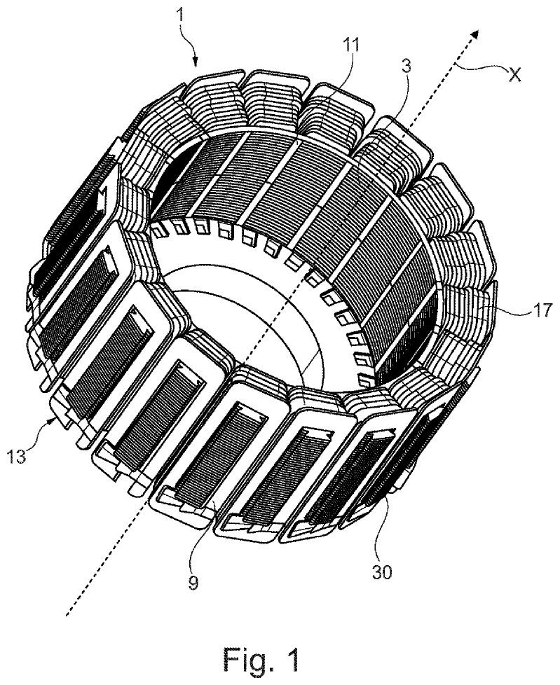

FIG. 1 shows a schematic perspective view of a stator with separate teeth;

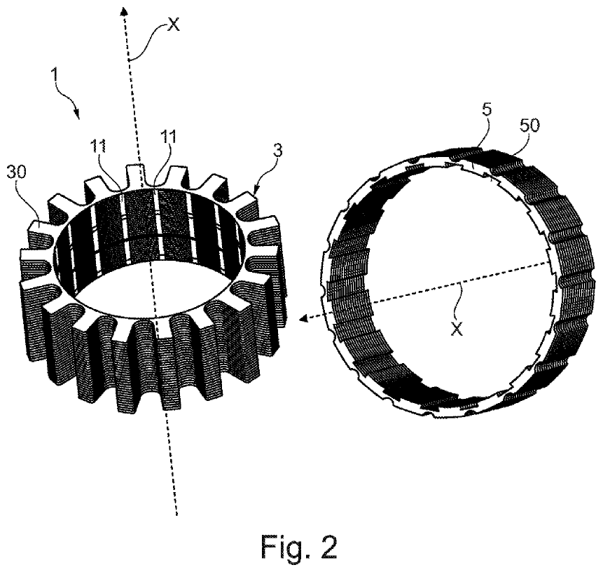

FIG. 2 shows a schematic perspective view of a star and a yoke of a stator body of an electric motor;

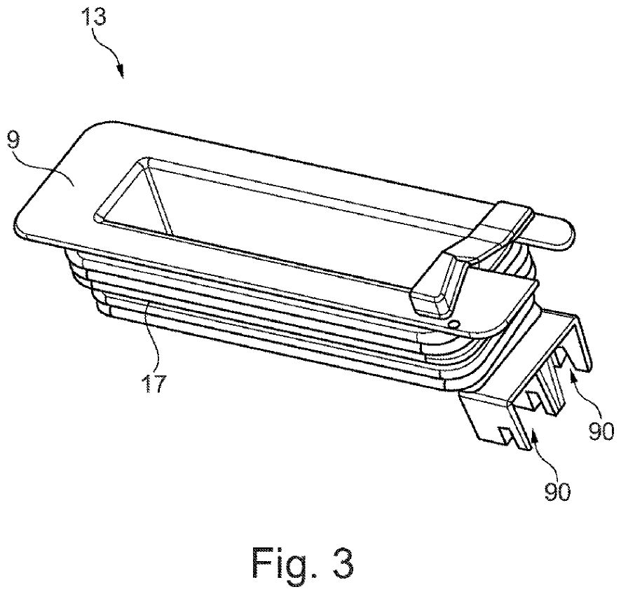

FIG. 3 shows a schematic perspective view of a coil produced around a bobbin forming a separate tooth of the stator of FIG. 1;

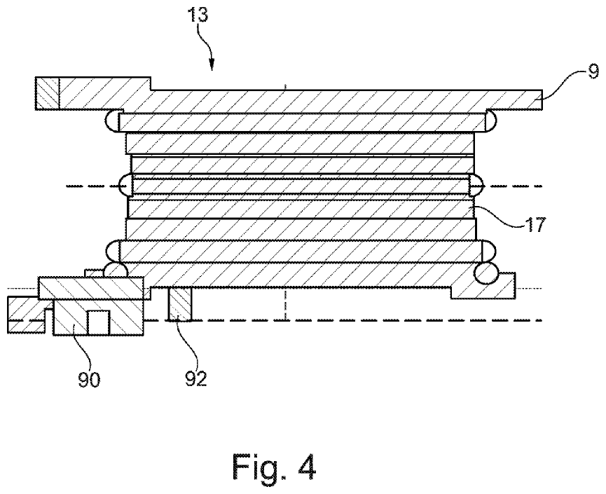

FIG. 4 shows a view, from a first side, of a bobbin according to the present invention;

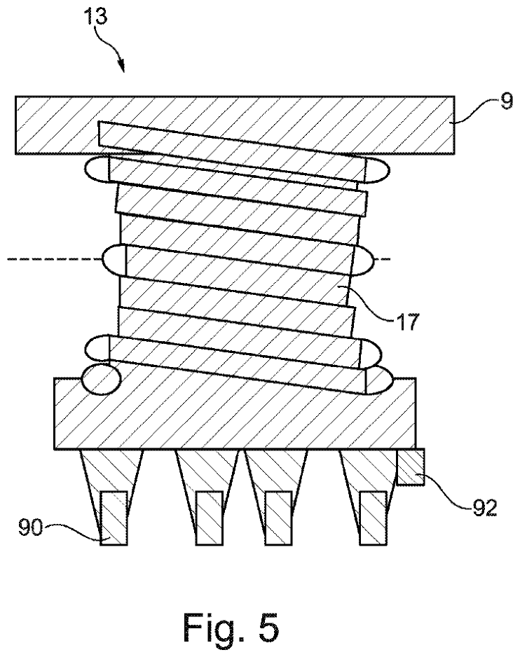

FIG. 5 shows a view, from a second side, of a bobbin according to the present invention;

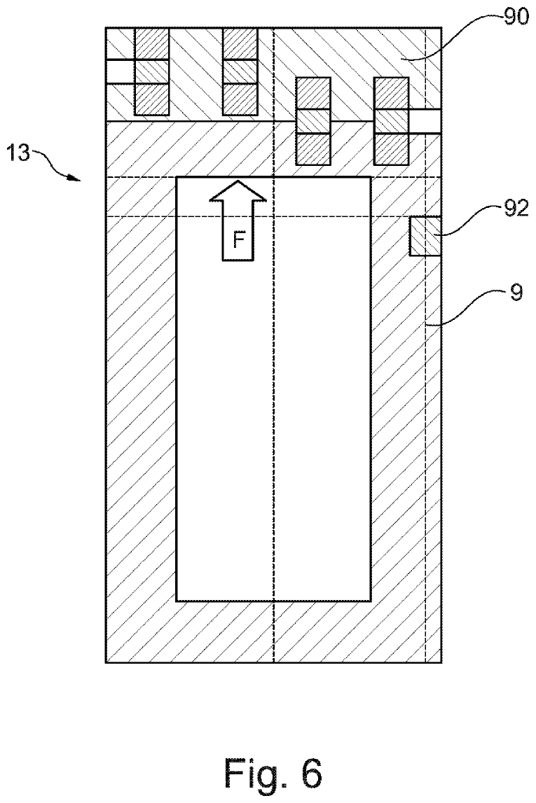

FIG. 6 shows a view, from beneath, of a bobbin according to the present invention;

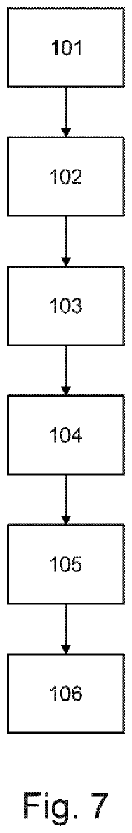

FIG. 7 shows a flowchart of the steps of a method for manufacturing a stator according to the present invention.

In these figures, identical elements have the same reference signs.

The following embodiments are examples. Although the description refers to one or more embodiments, this does not necessarily mean that each reference relates to the same embodiment, or that the features apply only to a single embodiment. Individual features of various embodiments may also be combined or interchanged to create other embodiments.

In the present description, certain elements or parameters may be indexed, for example first element or second element and also first parameter and second parameter or first criterion and second criterion, etc. In this case, this is simply indexing to differentiate and designate elements or parameters or criteria that are similar but not identical. This indexing does not imply priority being given to one element, parameter or criterion over another and such designations may be interchanged easily without departing from the scope of the present description. Neither does this indexing imply any chronological order for example in assessing any given criterion.

FIG. 1 depicts part of a stator 1 (the yoke 5 is not depicted in FIG. 1) for an electric motor, and particularly a separate-teeth stator 1 in which the coils 13 are formed by winding a winding wire 17 around a bobbin 9 configured to be positioned on a tooth 30 of a star 3 of the stator body 2. FIG. 2 depicts one exemplary embodiment of a stator body 2 comprising a central star 3 and a peripheral yoke 5 configured to be positioned around the star 3. The stator body 2 is obtained from a stack of sheet-metal laminations which are superposed and assembled with one another, for example by interlocking or grafting. The thickness of the laminations is for example 0.3 mm. The star 3 and the yoke 5 are for example obtained by cutting and assembling sheet-metal laminations, each lamination is thus cut out so as to obtain, on the one hand, a slice of star 3 and, on the other hand, a slice of yoke 5. The star 3 comprises a plurality of teeth 30, for example eighteen teeth 30, which are intended to receive a plurality of respective coils 13. The yoke 5 has a cylindrical overall shape and comprises a plurality of longitudinal slots 50 on its inner face, these being intended to receive the end of the teeth 30 of the star 3. The longitudinal slots 50 may have different cross-sectional shapes, for example rectangular cross sections or dovetail cross sections. However, the invention is not limited to these shapes of slots 50. The teeth 30 of the star 3 extend radially and their end has a shape complementary to the longitudinal slots 50 of the yoke 5. The star 3 is configured so as to be inserted into the yoke 5 by axial translation along the axis X. A plurality of openings 11 are also formed in the star 3, between the teeth 30, so as to encourage the circulation of the magnetic field in the stator body 2. The openings are formed in particular so as to prevent looping of the magnetic flux originating from the permanent magnets of the rotor that is intended to be positioned at the center of the stator 1. This is because looping of the magnetic flux through that wall of the star 3 that lies between the teeth 30 reduces the magnetic flux of the electric motor and therefore the performance of the electric motor. The width and the length of the openings 11 are determined in such a way as to reach a compromise between the mechanical strength of the star and the circulation of the magnetic flux. These openings 11 have a shape that is elongate, notably rectangular, in the axial direction. Thus, the openings 11 extend over a plurality of laminations. In the scenario of FIG. 2, three openings 11 are aligned in the axial length of the star 3, between each tooth 30, but a different number of openings 11 between each tooth 30 may be used. In addition, the number of laminations between the axial end of the star 3 and the opening 11 situated at this end is limited, for example to between two and five laminations, notably three laminations, so as to limit the tolerance on the dimension associated with the distance between the opening 11 situated toward the axial end of the star 3 and the axial end of the star 3.

FIG. 3 depicts an exemplary embodiment of a coil 13 formed by winding a plurality of turns of a winding wire 17 around a bobbin 9. The bobbin 9 for example has an annular overall shape of rectangular cross section. The winding may comprise several superposed layers of turns, for example three layers, the layers being produced one after the other. The winding may also be of the trapezoidal type, which is to say that the last layer of turns may cover just part of the axial length of the bobbin 9 so as to maximize the winding volume with respect to the space available between the teeth (there is more space available toward the outer radial end of the teeth 30). The bobbin 9 may comprise connectors 90 at one of its ends, notably two connectors 90 configured to accept the two ends of the winding wire associated with the coil 13 and to provide the electrical connection with the supply terminals of the stator 13. The bobbin 9 may be made of plastic. As depicted in the various views of FIGS. 4 to 6, the bobbin 9 also comprises a positioning pin 92 positioned on a part of the bobbin 9 that is radially internal when the bobbin is mounted on the star 3, which is to say on that side of the bobbin 9 that is directed toward the center of the star 3 when the bobbin 9 is mounted on the star 3. The pin 92 for example has a square or rectangular cross section and is configured to be positioned in a respective opening 11 of the star 3. The pin 92 is positioned in such a way as to come into contact with one end (short side) of the associated opening 11 so as to immobilize the bobbin 9 in axial translation in a given direction (axial translation of the bobbin 9 in the opposite direction being blocked by the internal side (identified by the arrow F in FIG. 6) of the bobbin 9 that is annular in shape of rectangular cross section, against the axial end of the tooth 30) and thus ensure the positioning of the bobbin 9 relative to the star 3 in the axial direction. The pin 92 is therefore positioned near one axial end of the bobbin 9, in this instance the end on which the connectors 90 are positioned. The pin 92 may have a chamfered part at its free end to facilitate its insertion into the opening 11. Thus, the coils 13 are mounted on the teeth 30 of the star 3 by inserting the positioning pins 92 in the openings 11 to ensure the axial positioning of the coils 13 with respect to the star 3, this also limiting the relative movement between the adjacent coils 13 and therefore reducing the risk of shorting between the coils 13. Once the coils have been positioned on the star 3, the yoke 5 may be positioned around the star 3 and the coils 13 using axial translation along the axis X.

The present invention also relates to an electric motor comprising a stator as described above. The electric motor is, for example, a three-phase motor.

The present invention also relates to a method for manufacturing a stator as described above. FIG. 7 shows a flow diagram of the steps of the manufacturing method.

The first step 101 concerns the stacking of laminations that are intended to form the star 3 and the yoke 5 of the stator 1 in an axial direction and the securing of the laminations together, for example by interlocking or grafting. The laminations are sheet-metal, for example steel, laminations. The thickness of the laminations is for example 0.3 mm. The stack has a substantially cylindrical shape.

The second step 102 concerns a step of cutting the laminations stack obtained in step 101. Cutting makes it possible to form, on the one hand, a star 3 comprising a plurality of uniformly radially extending teeth 30 and, on the other hand, a yoke 5 comprising a plurality of slots 50 having a shape complementary to the ends of the teeth 30. The ends of the teeth 30 and the slots 50 may have rectangular or dovetail shapes, for example.

The third step 103 concerns the formation of openings 11 in the star 3, between the teeth 30. The openings 11 are for example formed by the removal of material, cutting out, stamping out or cutting into the star 3. The third step 103 may be performed at the same time as the second step 102.

The fourth step 104 concerns the winding of a plurality of turns of a winding wire 17 around a bobbin 9 to form a coil 13, for example using trapezoidal winding. This winding is repeated to form all of the coils 13 of the stator 1.

The fifth step 105 concerns the positioning of the coils 13 formed in step 104 on the teeth 30 of the star 3, the bobbins 9 being secured to the respective teeth 30 of the star 3. The positioning of the coils 13 involves introducing the positioning pins 92 of the bobbins 9 into the openings 11 of the star 3 in order to provide the axial positioning of the coils 13 relative to the star 3.

The sixth step 106 concerns the positioning of the yoke 5 around the star 3 comprising the coils 13. Positioning is carried out by axial translation.

Thus, the use of a star 3 comprising openings 11 formed between the teeth 30 to allow the circulation of the magnetic flux, and of bobbins 9 comprising a positioning pin 92 configured to be positioned against the edge of an opening 11 in order to block the axial translation of the bobbin 9, thus makes it possible to ensure the axial positioning of the coil 13 despite the wide tolerance on the axial length of the star 3 as a result of the stacking of laminations.

1. A stator for an electric motor,
the stator comprising:
a star comprising a cylindrical central part around which a plurality of teeth extend radially, and
a plurality of bobbins configured firstly to receive turns of a winding wire in order to form a coil, and secondly to be positioned around the respective teeth of the star,
wherein the star comprises a plurality of openings formed in the central part thereof between the teeth, and
wherein the bobbins comprise a positioning pin arranged on an inner radial part of the bobbin, and
wherein, when the bobbin is mounted on the star, the positioning pin is configured to be positioned in an associated opening of the star so as to position the bobbin relative to the star in the axial direction.

2. The stator as claimed in claim 1,
wherein the bobbins have an annular overall shape of rectangular cross section.

3. The stator as claimed in claim 1,
wherein the openings formed in the central part of the star are configured to allow the magnetic field to circulate.

4. The stator as claimed in claim 3,
wherein the openings have a rectangular shape and the pins have a square or rectangular shape and are configured to come into contact with an edge of a respective opening in order to immobilize the bobbin in axial translation relative to the star in a first direction,
wherein the immobilization of axial translation in the second direction is provided by an internal wall of the bobbin in contact with a wall of the tooth.

5. The stator as claimed in claim 1,
wherein the positioning pins comprise a chamfered part at their free end to facilitate insertion of the positioning pin into an opening of the star.

6. The stator as claimed in claim 1,
wherein the star is formed from a stack of sheet-metal laminations assembled with one another in an axial direction.

7. The stator as claimed in claim 1,
wherein the positioning pin is positioned facing an opening situated at one axial end of the star,
wherein the positioning pin is configured to come into contact with that edge of the opening that is situated at the axial end of the star.

8. The stator as claimed in claim 1,
further comprising a yoke of cylindrical shape configured to be positioned around the star and the coils.

9. The stator as claimed in claim 1,
wherein the yoke and the star are formed by cutting from a stack of sheet-metal laminations configured to be superposed axially.

10. An electric motor comprising a stator as claimed in claim 1.

11. A method for manufacturing a stator as claimed in claim 1,
the manufacturing method comprising:
cutting a stack of sheet-metal laminations to form a star comprising a plurality of teeth, and a yoke comprising a plurality of slots having a shape complementary to the ends of the teeth,
forming a plurality of openings in the star between the teeth,
forming the coils by winding a winding wire around bobbins comprising a positioning pin on a part that is radially internal when the bobbin is mounted on the star,
positioning the coils on the teeth of the star,
wherein the positioning pin of the bobbins is inserted in an opening of the star,
inserting the star into the yoke using axial translation.
